(19) United States
(12) Patent Application Publication
(10) Pub. No.: US 2014/0043682 A1
(43) Pub. Date: Feb. 13, 2014

(54) Flip Up Interchangeable System

(71) Applicants: Patrick Hussey, Marina Del Rey, CA (US); Donn K. Harms, Del Mar, CA (US); Donald Harms, Del Mar, CA (US)

(72) Inventors: Patrick Hussey, Marina Del Rey, CA (US); Donn K. Harms, Del Mar, CA (US); Donald Harms, Del Mar, CA (US)

(21) Appl. No.: 13/880,968

(22) PCT Filed: Oct. 21, 2011
(86) PCT No.: PCT/US11/57396

§ 371 Date: Apr. 22, 2013

Related U.S. Application Data
(60) Provisional application No. 61/405,545, filed on Oct. 21, 2010.

(51) Int. Cl. G02B 27/22; G02C 9/02

(52) U.S. Cl. CPC G02B 27/2228; G02C 9/02
USPC 359/466

(57) ABSTRACT

Eyewear having a pivoted engagement of lenses with a lens frame worn on the head of the user. A lens assembly holding the lens or lenses is rotatable out of the user's view when not required for viewing such as when conversing with a friend or when wearing tinted lenses and needing unfiltered viewing. Biasing of the rotatable assembly provides for automatic rotation upward out of the field of view of the user upon release of a retaining component. The rotational engagement of lenses relative to a head worn frame may be employed in combination with prescription lenses, sunglass lenses, or 3D filtering lenses for viewing 3D media in the same rotational engagement and in one mode of the device are removable.

### BACKGROUND OF THE INVENTION

1. Field of the Invention

This application is a continuing in part application to PCT Application Serial Number PCT/US11/57396, filed Oct. 21, 2011 which claims the benefit of U.S. Provisional Application No. 61/405,545, filed Oct. 21, 2010, both of which are incorporated herein in respectively in their entirety by this reference.

The present invention relates to flip up interchangeable lenses, shields, guards, or the like for face and eye wear such as glasses, goggles, face shields or helmets. More particularly, the disclosed device and method relate to eyewear employable for polarized or shaded viewing or viewing 3D videos, games, or movies. From an as-viewed or as-used position in the line of site of a user, the lenses may be rotated out of the user's view when not needed to a stored position, thereby rendering their view as normal or unfiltered. Further, the device provides such selectable polarized or filtered or 3D lenses which may be worn singularly or in combination with prescription lenses.

2. Prior Art

Sunglasses and protective lenses have been provided for years. More recently, three Dimensional (3D) appearing movies, games, television shows, and other projected or displayed videos have evolved to employ a number of schemes to provide the viewer with a virtual 3D view of what is being viewed. Such 3D media provide this user-perceived sense of 3D by employment of projection and/or video display standards whereby two images are displayed in a viewing area. These images when viewed through both of the user's eyes are perceived by the brain as a single 3D video, game, movie or the like.

To provide a stereoscopic motion picture perceived as 3D by viewers, two images of the displayed media are projected and superimposed onto the same viewing area or screen through the use of different colorized or polarizing filters. To the naked eye, the projected or displayed image in this fashion appears hazy or shadowy.

In order for the viewer to perceive in their brain, the intended 3D version of the displayed media, it is required that the viewer wear, in front of each eye, a lens having optic qualities which are adapted to make one of the two images contained in the stereoscopic image appear clear to the respective eye through which it provides an image.

One mode of such individual lenses employs different colored lenses. Such have been used since the 1950's when 3D movies first became popular. The media is filmed and/or projected with the stereoscopic image containing both images and by wearing the colorized lenses, the viewer perceives one respective image through each eye.

Modernly, the two images making up the stereoscopic image employ polarizing filter schemes to both, combine them into the displayed stereoscopic image and separate them into two individual image streams. Each such image screen is to be seen by a different respective eye of the user. These individual images are cleared for each respective eye by the employment of two differing polarizing filters. Using this mode, one filter having a first polarizing quality is placed in front of one respective eye, and a second polarizing filter having a second polarizing quality opposite the first, is placed in front of the second eye. Each respective filter passes only that light which is similarly polarized and concurrently blocks the light polarized in the opposite direction.

With the individual lenses in a registered relative engagement with each other, so placed in front of a viewer's eyes, each eye sees a different image. The two images are used to produce a three-dimensional effect by projecting the same scene into both eyes, but depicted from slightly different perspectives. Because the users need not track the moving images on a stationary screen or projection area, such as in a theater, a plurality of people wearing similar pairs of lenses can view the stereoscopic images at the same time and all will perceive a 3D view of what is displayed.

However, such a mode presents vision and other complications, especially when the viewers are not sitting stationary and quiet in a dark theater. First, standards can change, or even vary between media providers. For instance, a game program running on a computer and video screen may employ a differing polarization scheme, or lens scheme from a movie projected inside a theater with stationary viewers. The game may have more than one player who are moving and positioned at differing angles to the screen and require a different or adapted polarization scheme from that of the movie. Alternatively, some manufacturers or providers of media may wish to control users by providing a proprietary lens scheme wherein the users must use lenses with a specialized or customized polarization and/or colorization scheme to see the 3D video.

Further, where customized lenses might not be required, users watching media at home or playing 3D video games, may wish to temporarily dismount their lenses, say to eat or greet a pizza delivery, and then easily go back to the 3D game, movie, or TV program. Or, viewers may need one polarization or colorization scheme for the lenses for a movie or TV program on a video screen, and another polarization or colorization scheme for a video game or playing a DVD movie. Or, the DVD movie or the video game may have a proprietary set of 3D lenses using a proprietary polarization scheme to maintain licensing or sales rights and fight pirating. This could be done by randomly changing the relative polarization angles of the lenses to each other, and electronically changing the game or movie to match. Thus, viewers of multiple types of media need multiple 3D lenses.

Still further, viewers and users who must wear corrective glasses currently are unable to easily employ 3D viewing lenses in combination with their prescriptive lenses. Such a combination can be used, but without the best results due to misalignment of the corrective lenses with the 3D polarizing or colorization lenses. Should multiple types and schemes of 3D viewing lenses be required for different games, movies, videos, or for proprietary schemes for games and media, prescriptive lens wearers are at even more of a disadvantage due to the inability to easily align and change their 3D viewing lenses with their prescription lenses.

Additionally, 3D imaging continues to evolve and new projections and user viewing schemes are being presented constantly. As a consequence, manufacturers of video games all playing in the same game player, may actually use different 3D technologies requiring differences in eyewear to perceive. Further, even on the same DVD player, different studios or producers may employ differing 3D technologies which may require different or reconfigured eyewear to watch and enjoy.

As such, there is a continuing unmet need for an improved device of easily engaged and aligned 3D lenses and/or optical components, which will provide for an easy interchangeability of the lenses and a plurality of auxiliary lenses, to allow viewers to adapt their 3D eyewear to the 3D media projection scheme of the game or media being viewed. Such a device should provide a registered engagement of the two individual 3D lenses with each being positioned in front of the appropriate eye, yet should allow for a quick temporary positioning of the lenses out of the line of sight so the user may temporarily see clearly for other tasks the lenses may impair or make inconvenient. Still further, such a device and method should provide for the registered engagement and positioning of each of the 3D lenses with each other, and the user's eyes, for 3D media and concurrent use thereof with prescription lenses of users. Still further, such a device and method should be applicable across a wide variance of media and potential proprietary or licensed polarization and colorization schemes to allow for lenses to be changed in such instances.

### SUMMARY OF THE INVENTION

The device and method of employment herein disclosed and described achieves the above-mentioned goals through the provision of an eyewear system configured for registered engagement of colorized or polarized 3D lenses. Should a single 3D lens scheme such as circular polarization be employed, the user is provided with a means to remove the 3D lenses temporarily from their line of sight, using a means for rotatable engagement of a forward positioned lens body holding one or a plurality of lenses to a rearward frame which is adapted for positioning on the user's face using straps or temples or other means to secure the rearward frame in an operative position.

In a particularly preferred mode, the lens body holding the 3D lenses in a registered engagement to each other, is removably engaged to the rearward frame. This will allow for the engagement of one or a plurality of lens bodies holding different lenses in registered engagement with each other to match the polarization scheme of one or a plurality of different game, video, TV, movie, or other visually displayed programs. Should a game have a different polarization and/or colorization criteria for 3D viewing than say, a movie playing on a LCD video screen, the user simply engages a lens body having the appropriate lenses already operatively engaged in a registered engagement with each other, for the media to be viewed.

The means for engagement of the lens body to the rearward frame may allow for a static mount of the lens frame, or more preferably, would allow for a rotational engagement of the lens frame. The rotational mount allows the user to easily and temporarily remove the 3D lenses from their line of sight for temporary time periods without removing them from engagement to their head.

Still further, in a preferred mode of the device, both the static mount and the rotational engagement mount would preferably allow for removable engagement of a plurality of different lens frames to the rearward frame. This allows the user to engage the proper lens frame having the proper lenses in their registered engagement with each other for the media to be viewed, to be engaged and later removed. This allows a second or third or infinite amount of lens frames holding colorized or polarized lenses in registered engagement with each other to match the requirements of the video, game, movie, or other media to be viewed. This mode also allows for media producers to provide proprietary lenses to customers adapted to render only their media in 3D without which the media is unclear. In this fashion lenses may be sold with movies or sports events and the like, and mounted and dismounted as needed.

Thus, the disclosed device and method allow for the utilization as a licensing or control on users and pirating through the provision to allow changing polarization schemes for 3D media. Using the device and this anti-pirating and licensing method, media providers can program their media with proprietary colorization and/or polarization, which works to provide a clear picture and 3D only with lenses adapted to their media. This can be employed to help curb pirating of media, or say for instance to control the number of viewers for pay-to-watch kick boxing or prize fights which would be viewed in 3D. By changing the angle of the polarization of each lens, to match a proprietary scheme, and broadcasting or providing the video in that proprietary scheme, only users who can mount the proprietary 3D lenses which match the proprietary mode of the media provider will be able to see clearly and in 3D. For prize fights for instance, frames bearing the lenses at the correct polarization angles and/or colorization schemes could be provided only to paying users. This would prevent a large group of people from watching a prize fight if only one paid to have it broadcast.

In another mode of employment of the device and method herein, video game makers could “synthetically” polarize the output of the video game using software and/or hardware to enable a changing or random polarization scheme which would be revealed to users upon change. This would require the user to change to lens frame bearing polarized and/or colorized lenses which match game-disclosed scheme to see clearly or 3D.

Further, game makers employing the system herein, may change the polarization angles presented to the game player every so often. This would require a few sets of lenses at the appropriate polarization angles which the game might choose. Whenever the game software changes polarization schemes it will give the players an “adjustment code” which would be the code of the individual frame holding the two lenses at the appropriate polarization angles. The users would dismount the old lens frame and engage the designated one. Should pirating become overbearing the manufacturer on the next game update over the internet could change the game to adopt a new polarization scheme and then send frames bearing lenses matching the new scheme to users.

Employing the head mounted frame which is removably engageable to a lens frame bearing the lenses in the appropriate angle to each other, the system herein is easily adapted to this mode of operation. Further the system herein is easily adapted to allow for the engagement of 3D lenses in combination with prescription lenses a user may need. In this mode, the head engaged rearward frame may have an existing second lens, such as a prescription corrective lens.

The rearward positioned frame is engaged on the user's head by a securement means such as conventional temple elements or straps. The removably engageable and/or rotatable front lens body holding one or a plurality of lenses, preferably is adapted to bias to one or a plurality of positions automatically. The current preferred positions include a substantially horizontal stored-position out of eyesight of the user, and an as-used position operatively inline with the rearward frame and the user's eyes. The device would automatically move to the stored-position horizontal from the vertical in-use position when needed by releasing a lock holding the lenses vertical and as-used. A number of biasing means to cause the lens frame and lenses to bias toward the horizontal position may be employed, such as a detent mechanism which is spring biased, ball type spring plunger, or a magnet. The biasing means may also provide intermittent locations of bias other then the positions specified while the specified locations were given only as simple descriptions.

Additionally, since it is biased to an upward position, the front positioned lens body is rotationally biased to flip up to the horizontal biased position easily with a flick of the finger through the provision of a spring loaded hinge or the like. This rotational bias preferably is not great enough to overcome the positional bias achieved by the detent mechanism, magnet or the like but is present to cause the rotation when the bias or lock is overcome by the user. User input is required to overcome the positional bias achieved by the biasing means while the substantially horizontal position is the default position achieved by the rotational biasing means once disengaged from the positional bias.

In another mode a securement means is removably engaged to an existing corrective eyeglass in a ‘clip-on’ fashion. This engages a mount to the existing eyewear which may employ any of the mounting schemes noted herein. This will provide any of the above mentioned interchangeability and rotational positioning of the auxiliary lens frame and lenses without the need for a rearward frame as described since the eyeglass frame functions there as.

Additionally, in yet another mode, the temple element of the main frame employs a means to connect earphones or electronic devices of the like to allow for on-the-go use. The means for engaging the earphones may be permanent or removable such as but not limited to adhesive or snap-fit fasteners, respectively.

With respect to the above description, before explaining at least one preferred mode of the herein disclosed 3D lens mounting and positioning device and method in detail, it is to be understood that the invention is not limited in its application to the details of construction and to the arrangement of the components in the following description or illustrated in the drawings. The invention herein described is capable of other modes and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of this invention to provide a means to couple one or a plurality of interchangeable auxiliary lenses in operative positioning with the eyes of the user and a head worn frame.

It is a further object of this invention to provide one or a plurality of pairs of registered 3D lenses for use by users for 3D media interchangeably with the same main frame.

It is another object of this invention to provide a means to rotationally bias the lens bearing frame to rise to an out of sight position.

Still an object of the current invention is the provision of a single centrally located hinge mount point or pair of such mounts located a positions mirrored about the nose bridge of the frame.

Yet another object of this invention is to provide releasable engagement of the front lens body bearing a pair of lenses in a registered polarization engagement, to the rearward frame.

A further object of the invention is the provision of a means to engage earphones or electronic devices of the like to the rearward frame.

### BRIEF DESCRIPTION OF DRAWING FIGURES

FIG. 1a is a perspective view of a first mode of the device allowing for the method herein wherein one or a plurality of lens bearing frames “L” are engageable using engagement element “M” to a helmet.

FIG. 1b is another view of the device of FIG. 1a.

FIG. 1c is a perspective view of another mode of the device similar to 1a.

FIG. 2a is a perspective view of another mode of the device wherein the lense frame “L” is engaged to a rearward frame using an engagement element “M”.

FIG. 2b is a perspective view of a second mode of the device of FIG. 2a.

FIG. 2c is a perspective view of another mode of the device wherein lenses engage a frame.

FIG. 3a is a perspective view of a third mode of the device where the rearward frame having the engagement element “M” is a goggle body and the lens frame “L” is a lens.

FIG. 3b is a perspective view of another mode of that of FIG. 3a.

FIG. 3c is a perspective view of another mode of that of FIG. 3a.

FIG. 4a is a perspective view of another mode of the device employing a shield with a head engaged frame.

FIG. 4b is a perspective view of another mode of the device of FIG. 4a.

FIG. 4c is a perspective view of another mode of the device of FIG. 4a.

FIG. 5a is a perspective view of another mode of the device employing lenses in registered engagement with each other which attach to a frame.

FIG. 5b is a perspective view of another mode of the device of FIG. 5a.

FIG. 5c is a perspective view of another mode of the device of FIG. 5a.

FIG. 6 is a perspective view of device with lens element biased to the stored position out of sight of the user.

FIG. 6b depicts operational qualities of one conventionally popular mode of 3D eyewear employing circular polarization.

FIG. 6c is another view of the lens element

FIG. 7 shows the device in a stored position applicable to all modes and modes where it is biased upward to a substantially horizontal position after release of a restraint.

FIG. 8 depicts the as-used position of the auxiliary lens, also biased to maintain the position.

FIG. 9a shows a top view of a first detailed mode of the first component in the securement means depicting a spring loaded biasing hinge and rotating body with opposing flange elements.

FIG. 9b is a perspective view.

FIG. 10a is a top view of a first mode of the second component of the releasable securement means.

FIG. 10b is a side view depicting a slot with frictional engagement elements.

FIG. 10c is a perspective view.

FIG. 11a is a top view of a second mode of the first component in the securement means with stationary rectangular body with opposing flange elements.

FIG. 11b is a perspective view.

FIG. 12a is a top view of a second mode of the second component of the releasable securement means.

FIG. 12b is a side view.

FIG. 12c is a perspective view.

FIG. 13a is a third mode of the first component in the securement means with rotating body comprised of a actuating release mechanism and engagement hub.

FIG. 13b is a perspective view.

FIG. 14a is a top view of a third mode of the second component of the releasable securement means.

FIG. 14b is a perspective view.

FIG. 15a depicts a top view of the third mode of the securement means prior to engagement.

FIG. 15b depicts a top view of the third mode of the securement means engaging the lens and frame components.

FIG. 15c shows the actuating release mechanism of the third mode of the frame component disengaging the securement means.

FIG. 16a is a top view of a fourth mode of the first component of the releasable securement means.

FIG. 16b is a perspective view.

FIG. 17a is a top view of a fourth mode of the second component of the releasable securement means.

FIG. 17b is a perspective view.

FIG. 18a is a top view of a fifth mode of the first component of the releasable securement means.

FIG. 18b is a side view in the as-used position.

FIG. 19a is a top view of a sixth mode of the first component of the releasable securement means.

FIG. 19b is a perspective view.

FIG. 20a is a perspective view of a seventh mode of the releasable securement means.

FIG. 20b is an exploded view.

FIG. 21a is a top view of a eighth mode of the first component of the releasable securement means.

FIG. 21b is a side view.

FIG. 22a is a side view of the eighth mode of the first component of the releasable securement means.

FIG. 22b is a side view of the eighth mode of the first component of the releasable securement means.

FIG. 22c is a side view of the eighth mode of the first component of the releasable securement means.

FIG. 23a is a top view of a ninth mode of the first component of the releasable securement means.

FIG. 23b is a perspective view.

FIG. 24a is a top view of a ninth mode of the second component of the releasable securement means.

FIG. 24b is a perspective view.

FIG. 25a is a top view of the ninth mode of the releasable securement means.

FIG. 25b is a side view.

FIG. 25c is a side view.

FIG. 26a is a perspective view of a tenth mode of the securement means.

FIG. 26b is a perspective view of a tenth mode of the securement means.

FIG. 26c is a perspective view of a tenth mode of the securement means.

FIG. 27a is a top view of an eleventh mode of the first component in the releasable securement means.

FIG. 27b is a side view.

FIG. 27c is a perspective view.

FIG. 28a is a top view of an eleventh mode of the second component in the securement means.

FIG. 28b is a perspective view.

FIG. 29a is a side view of a twelfth mode of the first component in the releasable securement means in the stored position.

FIG. 29b is a side view of a twelfth mode of the first component in the releasable securement means in the as-used position.

FIG. 30 is a perspective view of an mode of the device showing magnetic closures.

FIG. 31 is a perspective view of another mode of the device showing magnetic closures.

FIG. 32 depicts a view of an mode of the as-used biasing means of the device with a plurality of slide-lock biasing means.

FIG. 33 depicts a view of an mode of the as-used biasing means of the device with a single centrally located slide-lock biasing means.

FIG. 34a shows a cross-sectional view of the open mode of the slide-lock biasing means.

FIG. 34b shows a cross-sectional view of the closed mode of the slide-lock biasing means.

FIG. 35 shows a perspective view of a clip on mode of the invention.

### DETAILED DESCRIPTION OF THE PREFERRED EMBODIMENTS OF THE INVENTION

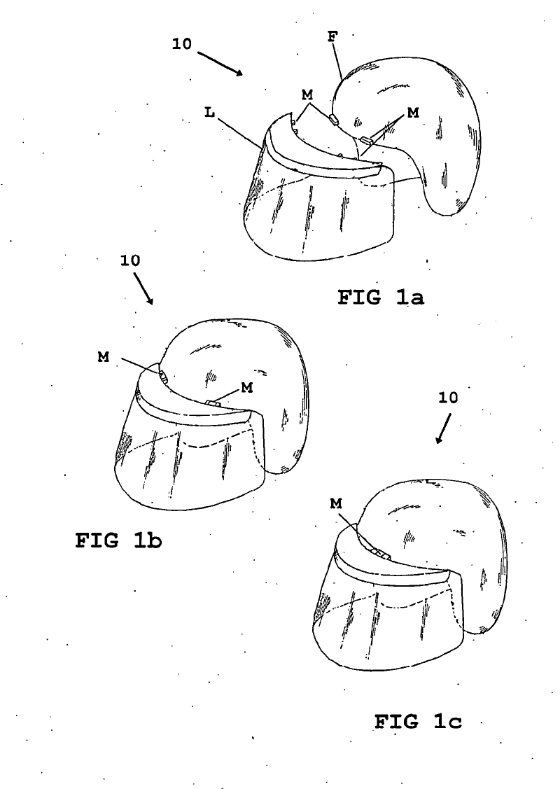

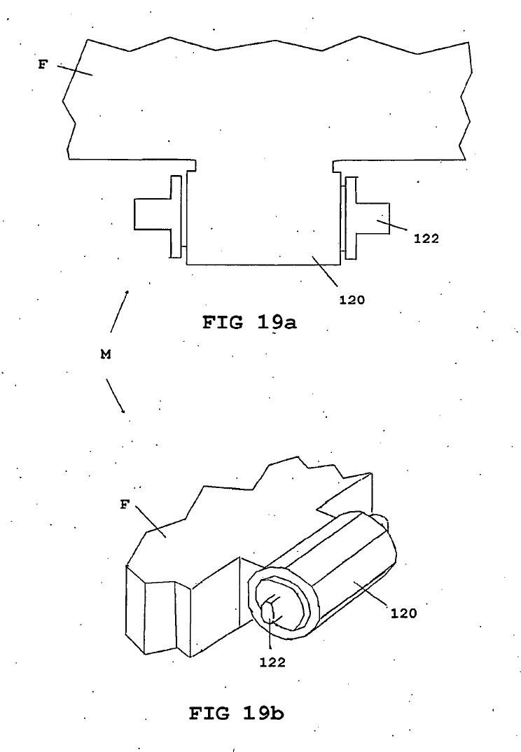

Referring now to the drawings of FIGS. 1-35, there is seen in FIGS. 1-5 the preferred modes of the device 10. Generally speaking, in all modes of the device, the device will incorporate some form of a rearward frame element F, a removably engaged and/or rotatable lens L, and one or a plurality of means for releasable securement M of the lens to the frame F and a means for securing the frame to a user's head such as a strap or temple elements. This arrangement allows a single frame element F of any type to engage one or a plurality of frame elements F of any type thereby allowing interchangeability of the optics provided by the lens element L for 3D schemes of any type. Further, the lenses may be clear, tinted and/or polarized and when employed for use with one or with a plurality of interchangeable 3D lenses “L”, each would have a right “R” and a left “L” optic or lens area. In a 3D mode, each of the two optics would be in registered engagement and positioning relative to the other to provide the correct 3D filtering, to match the horizontal or circular polarization technology being employed to present media for viewing, be it a game, movie, DVD, video, or other type of move or picture.

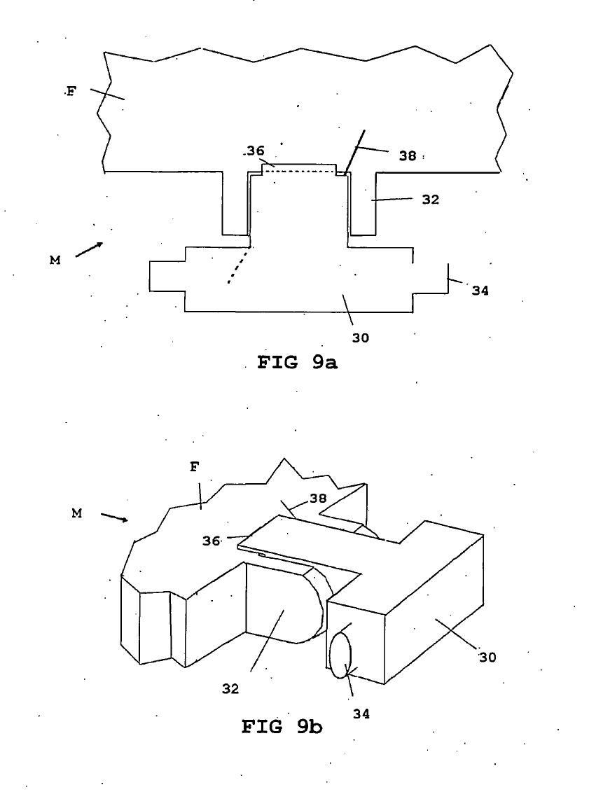

In all modes cooperatively engaged first and second mounting components, namely lens “L” and frame “F” components, employ the releasable or permanent securement means “M” with preferred modes described in detail in FIGS. 9-29. It should be noted these rotatable and/or removable means for engagement of a lens to the underlying frame, may be used with eyewear not shown herein and provide great utility alone, and such is anticipated within the scope of this patent.

FIG. 1a depicts a first mode of the frame F, in the form of a helmet with face shield providing the lens L. FIG. 1b shows the closed mode of the device with lens L in-line in operative engagement with the helmet frame, F depicting multiple securement mounts M. FIG. 1c again shows the closed mode with a single substantially central mounted securement mounts M.

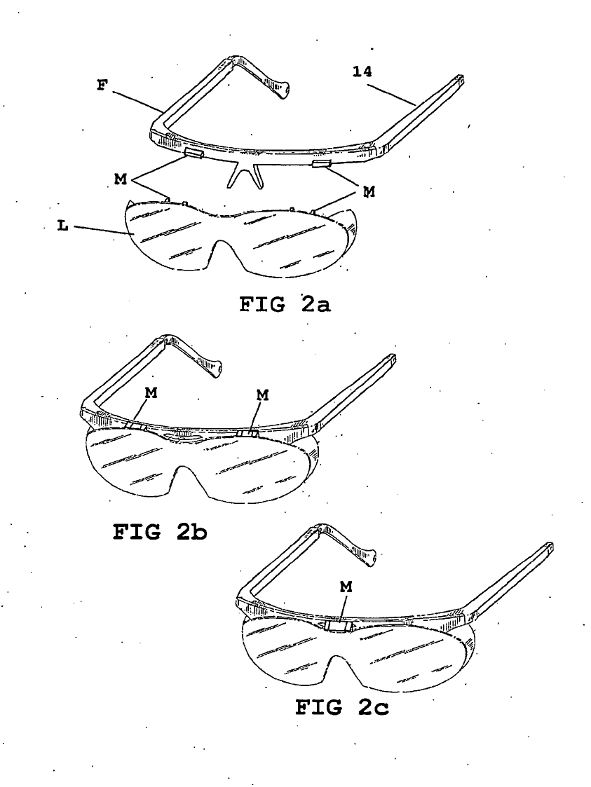

FIG. 2a shows a second mode of the device 10 depicted as an eye shield having a frame F and lens L. FIG. 2b shows the closed mode of the device with multiple securement means M holding the lens L in the as-used position. FIG. 2c also shows the closed mode with a single centrally mounted means for securement M holding the lens L in a registered engagement.

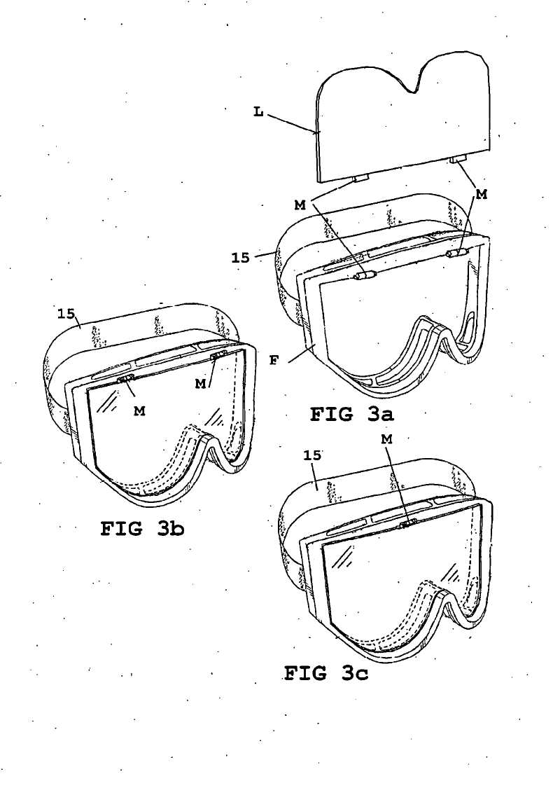

Shown in FIG. 3a is yet a third mode of the device. Depicted is a goggle with a goggle body as a frame F and lens L. A means to secure the frame to the head of a user is provided through the provision of a strap 15 shown. FIG. 3b shows the closed mode of the goggle mode of the device with multiple securement means M maintaining the lens L in operative position relative to the goggle body. FIG. 3c again shows the closed mode yet with a single centrally mounted means for securement M. In the mode in FIG. 3, if employed for 3D viewing as a filter, the Right and Left viewing optics would be positioned to be in front of the correct eye but as shown, formed into a single lens.

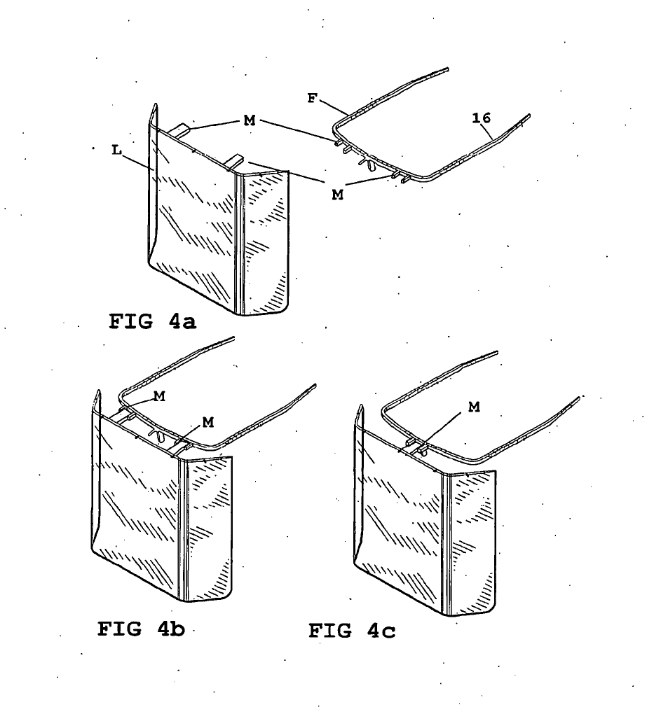

A fourth mode of the device is seen in FIG. 4a depicted as a face shield with frame F and removably engageable lens element L forming the lens L. The frame F employs conventional temple elements 16 as a means to secure it to a users head. FIG. 4b shows the closed mode of this mode with multiple securement means M located on the frame F. FIG. 4c again shows the closed mode yet with a single centrally mounted means for securement M.

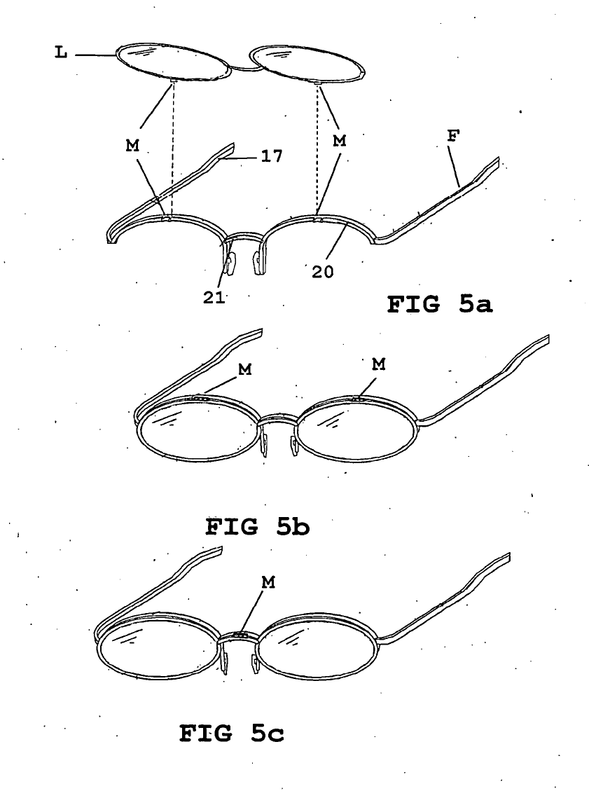

An additional preferred mode of the device is shown in FIG. 5a depicted with conventional eye wear frame F, and having a rotatable and preferably removable lens element L which may be a single element, or one of a plurality of types of such lens elements L configured to engage the frame F individually. For some demonstrative purposes herein the following descriptions and figures will be based upon the description of this mode while it should be noted that what is set forth substantially holds true for all modes described previously in FIGS. 1-4.

The frame element F also employs temple elements 17 as a means to secure it to a users head. FIG. 5b depicts the securement means M as two distinct elements M located about the frame's cross members 20 at a distance from the nose bridge 21. FIG. 5c depicts the means for securement M as a single member 18 located at the nose bridge 21 of the rearward frame F and lens L. It should be noted that both arrangements achieve the goal of coupling the front lens body L to the frame F while one may be preferred over another merely for aesthetic purposes. For demonstrative purposes some following figures may be depicted with either one or a plurality of such engagement means M while either will suffice to achieve any noted goals and should note be considered limiting.

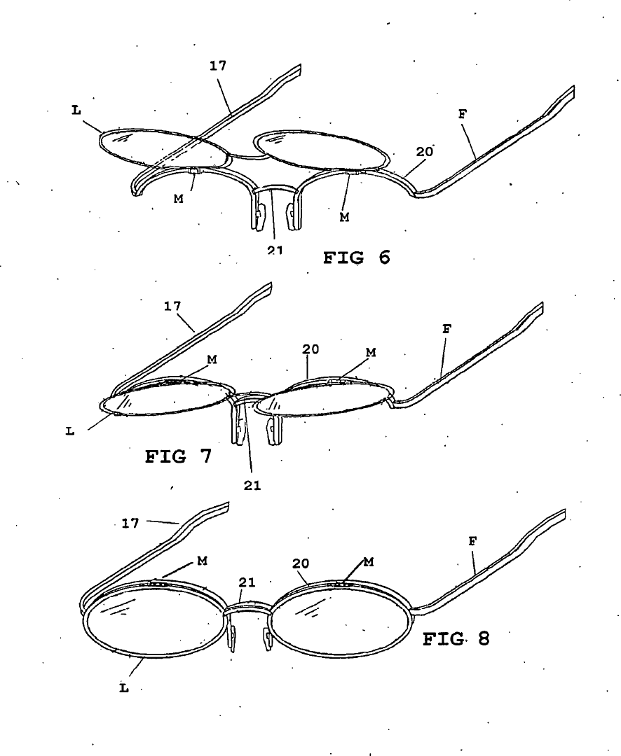

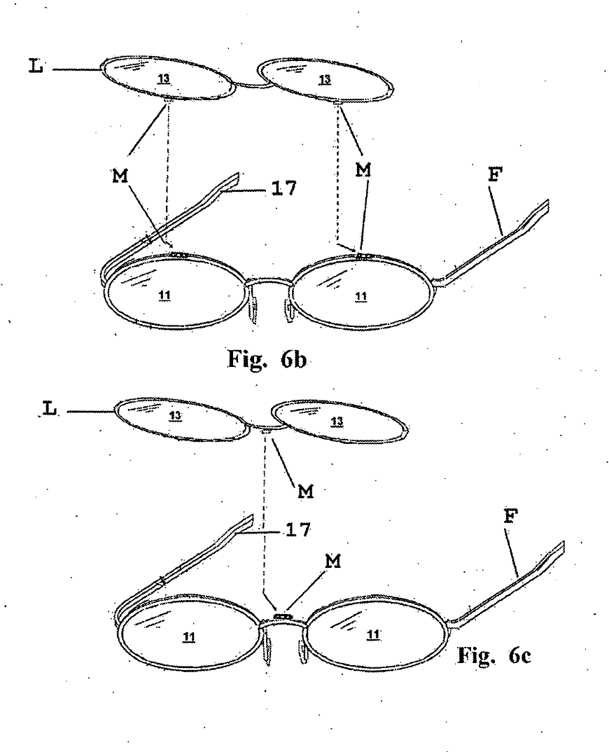

FIG. 6 shows the engagement of the lens L to a frame F with front lens body L at a slightly vertical flipped-up orientation. It is desired that the lens L must be positional to this orientation for engagement and disengagement to the frame to ensure no accidental disengagement at other positions happen as will be described shortly. The securement means M once engaged, restricts movement of the lens body L to rotational motion in combination to the frame F. In a vertical stowed configuration or vertical as-used configuration the lens L will not dismount, but will only dismount at the 40-70 degree inclination such as in FIG. 6.

FIG. 7 shows a substantially horizontal stowed position of the front lens body and lens L out of the line of sight of the user. A means for biasing the relative rotational position of the lens L engaged in the lens body, is achieved by provision of a means for biasing such as a spring, or a spring biasing a ball into engagement with a detent, magnets on one or both components to render them magnetically attractive, or other means to bias the lens frame holding the lens L to the stowed position when moved from the as-used position. In the as-used position the lens is held by a lock or means for temporary securement such as a second means for biasing similar to the above, or other means for temporary securement. Details of such means for securement in the as-used position are described in the different modes of the means for releasable securement shown in FIGS. 9-29. It must be noted that intermediate biased horizontal positions for a rotationally engaged lens L, may exist yet the position depicted in the figure is chosen merely for demonstrative purposes and should not be considered limiting.

The as-used positioning of the front lens body or component, holding one or two lenses L, is seen in FIG. 8. Here the lens body holding the lens L is held substantially vertically in-line in operative engagement with the rearward frame F by means for securement such as noted biased ball and detent or magnets as will be described in later figures. It should be noted that all depicted and described means for rotational positioning, from the stowed position to the as-used position can be employed with other eyewear and provide great utility and such is anticipated within the scope of this patent application and may be claimed separately. When the lens is moved from the as-used position, it is then rotatably biased toward a horizontal, or a vertical stowed-position, where a means for securement to removably maintain the lens in such position sufficient to resist the downward gravitational bias is employed. Once released, in all modes of the device with a biased lens L, the lens L will rotate toward a horizontal stowed position out of the line of sight of the user.

A mode of the device showing one means for releasable securement of the lens L to the frame F, is depicted as M and is seen in top view in FIG. 9a. The designation M is used heron to designate all means for releasable securement of a lens frame component to a frame component having temples or other means for engagement to a user's head.

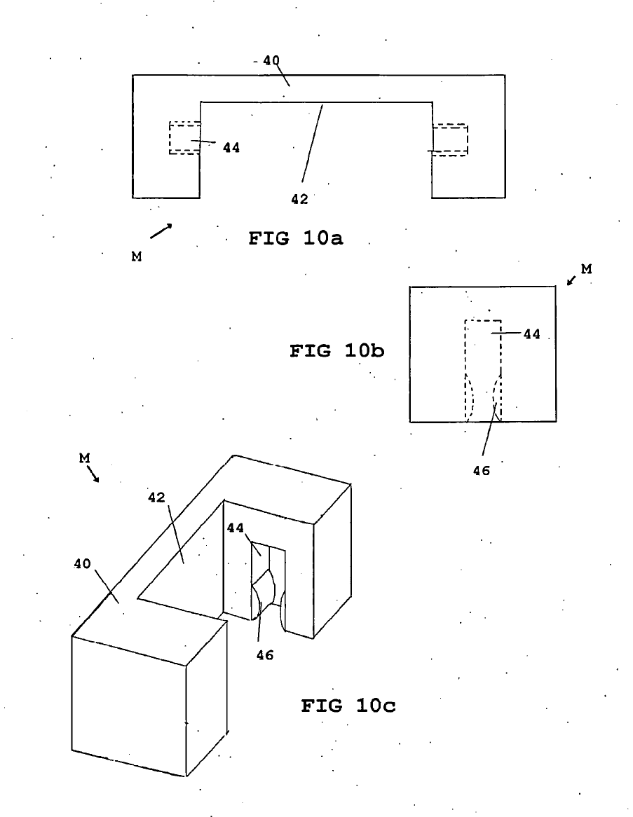

The frame F is seen engaged to a rotating lens body 30 at a hinge 32. The rotating lens body 30 employs opposing flange elements 34 and is continually biased toward a substantially horizontal flipped up or stowed position, through the provision of a spring 38. Over rotation is prevented by tongue 36 extending onto the frame F. A perspective view of this mode is seen in FIG. 9b. The respective engaging components which are engaged to the lens L that defines this means for securement M can be seen in its first mode in FIG. 10a. Depicted is a rectangular body 40 with clearance gap 42 for engagement with rotating lens body 30 or first component shown in the previous figure. Slots 44 engage cooperatively with the flange elements 34 and maintain engagement via friction elements 46. Side and perspective views of the current component can be seen in FIGS. 10b and 10c respectively.

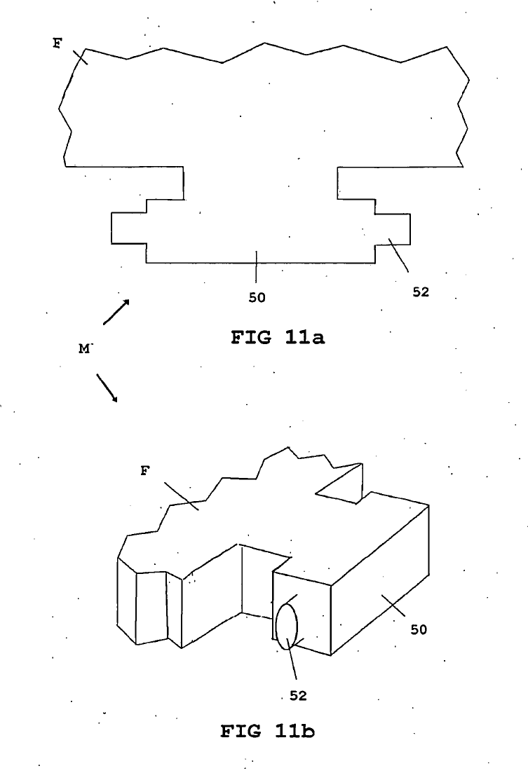

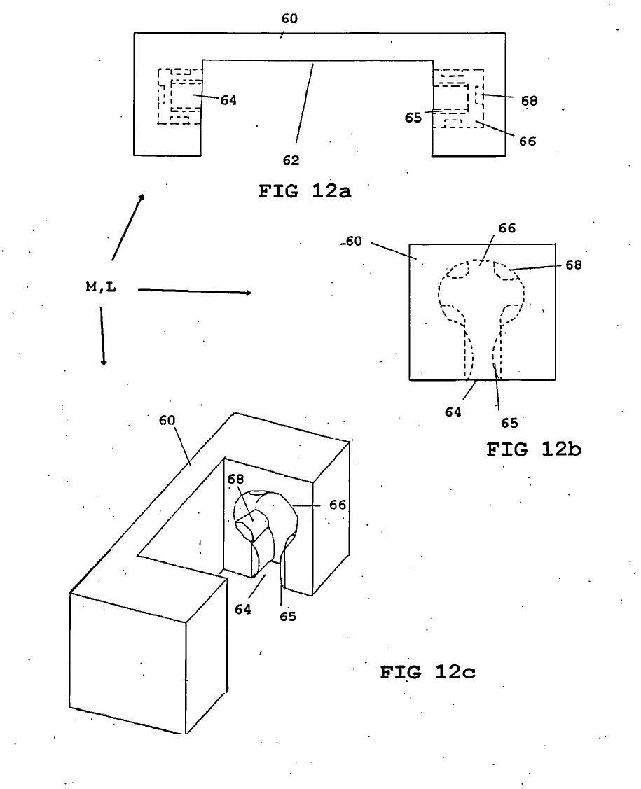

A top view of a second mode of a first component of means for securement M is seen in FIG 11a. The head-engageable body 50 is rigidly engaged to the frame F and employs opposing flange elements 52. A perspective view is seen in FIG. 11b. The second mode of the corresponding second component which is engaged to lens L, is seen in FIG. 12a. It is comprised of a rectangular securing body 60, which would be part of, or engaged to, a lens frame bearing lenses L, and has clearance gap 62. It is configured to engaged cooperatively with rigid body 50. Slots 64 with friction elements 65 also engage cooperatively with flange elements 52 to define a means for coupling. Clearance hole 66 with frictional biasing elements 68 rotates about the flange elements 52 defining rotational positionings which the lens frame bearing lenses L may assume, such as a substantially horizontal stored position and the vertical as-used position. Side and perspective views can be seen in FIGS. 12b and 12c respectively. These components may also work together with other means for biasing to bias the lens L in the as-used position as will be described later.

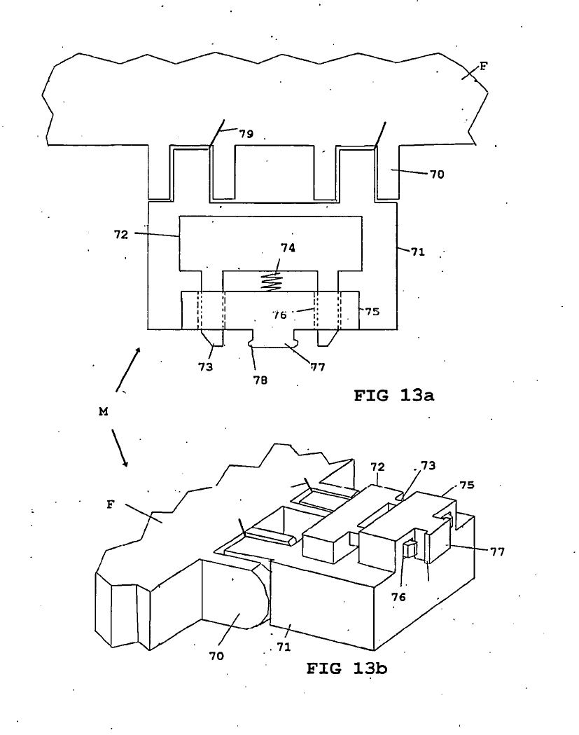

A third mode of a firs part or first component of a securement means M, is seen in FIG. 13a. As noted the rotational engagements herein may be employed with other eyewear.

Again, a rotating body 71 which would attach to or be part of the lens frame bearing the lenses L, is seen engaged to the frame F via hinges 70. The rotating body 71 is also biased to a flipped up or the stowed position by biasing spring 79. The rotating body 71 consists of an actuating release mechanism 72 and channeled extension 75 with channels 76 and engagement hub 77. The actuating release 70 is slidably engaged to the extension 75 via push-rods 73 within channels 76. The release 70 is biased towards the frame F by a biasing means such as a spring 74.

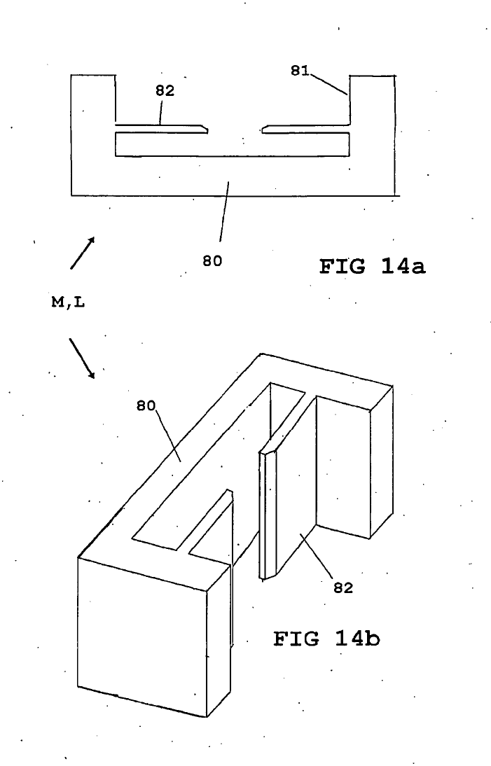

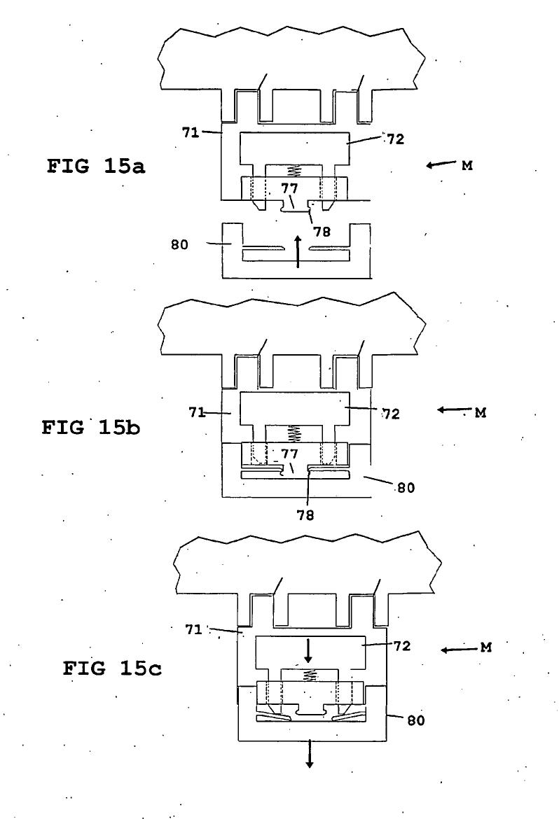

A perspective view of this mode of the device is depicted in FIG. 13b. The corresponding second component of the depicted third mode of a means for securement M of the lens bearing component, to the head engaged mount or frame worn by a user, is depicted in FIG. 14a. Rectangular body 80 has clearance gap 81 intended to engage cooperatively with the channeled extension 75. Within gap 81 are partitions 82 intended to engage cooperatively with the engagement hub 77 to define the securement means. A perspective view is seen in FIG. 14b. Steps for engagement of the two components are seen in FIGS. 15a-15c. Partitions 82 frictionally engaged behind the biasing protrusions 78 on engagement hub 77. To disengage, actuating release 72 is slid toward the second component 80 by the user. The push-rods 73 deflect the partitions 82 away from the engagement hub 77 allowing removal of the two components.

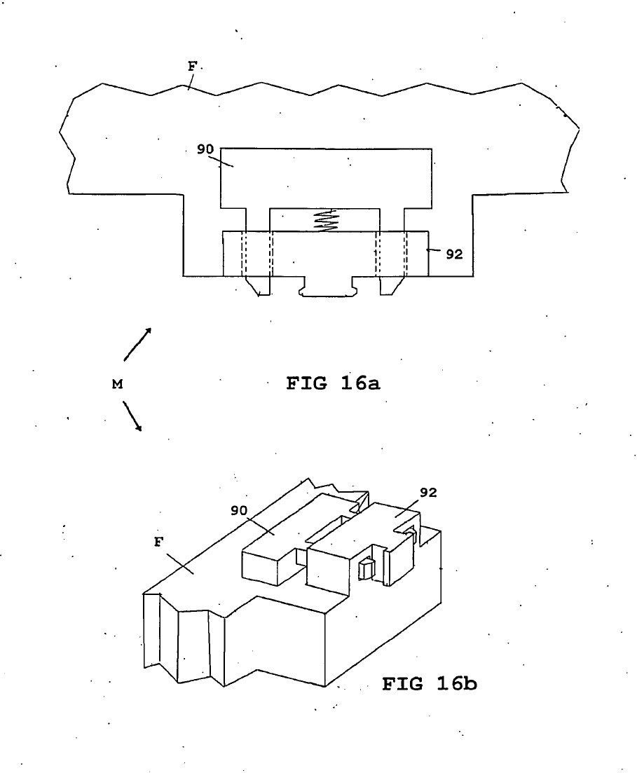

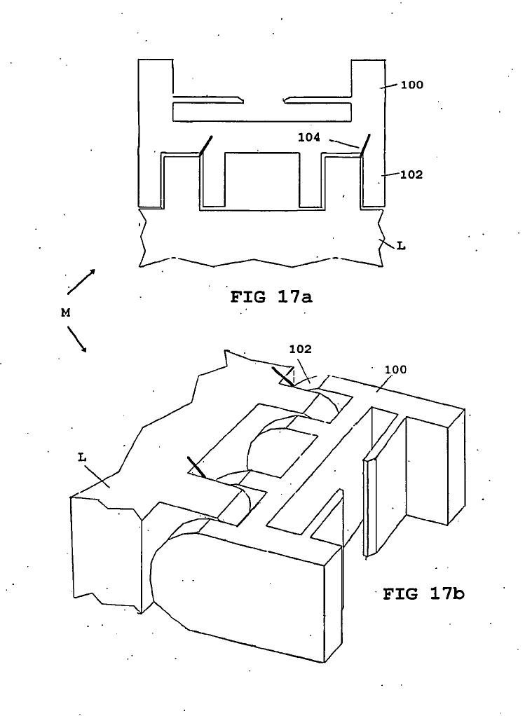

A fourth mode of a means for securement is shown with the first component of a means for securement M in FIG. 16a. Here, the actuating release 90 and channeled extension 92 as described previously, are instead rigidly engaged to the frame F. The second component can be seen depicted in FIG. 17a. In this mode the rectangular body 100 is rotatably engaged to the lens L via a hinge 102. Biasing springs 104 bias the lens L to a substantially flipped up position. Biasing in the as used position is achieved by a biasing means such as magnetic closures as will be described later.

Another preferred mode of a means for securement M is depicted in the figures of drawing 18, showing a first component of a means for securement M of a lens bearing component to a frame or member engaged to the head of a user. Channel 111 houses retaining spring 112 which biases ball 113 toward and into detent 115 of a rotating body 114. The rotating body 114 includes a plurality of detents 115 providing a positional configuration where the ball 113 will bias into the detent 115 and maintain lenses in position. The mechanism described in this figure can work concurrently with, or replace, the conventional spring loaded hinge as described in previous modes. Furthermore, the rotating body 114 can be replaced by any of the rotating bodies 30, 71, herein described in other modes.

A sixth mode of engagement showing the first component of a means for securement M is provided through the provision of a soft-close dampening hinge 120 system rigidly engaged to the frame F. The hinge system is internally biased to move the attached lenses to a flipped up position. The flanged rotating component 122 achieves engagement to the front body component holding lenses, (not shown) via the conventional flange/slot systems described in previous modes.

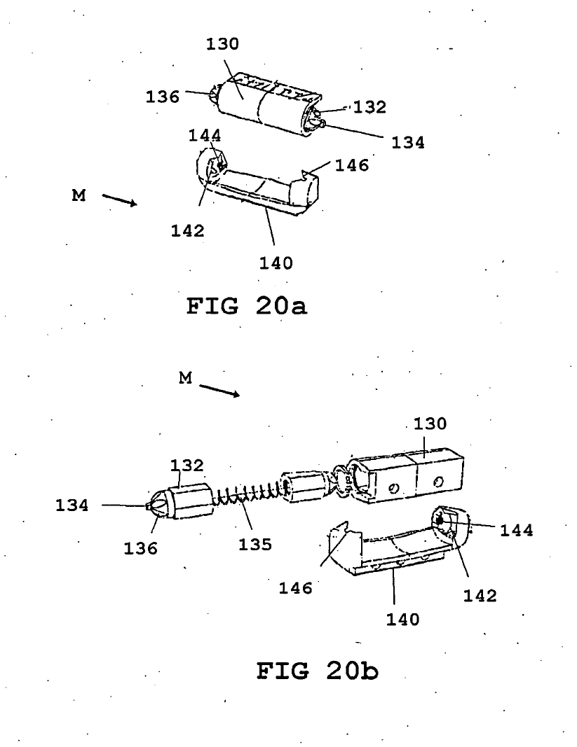

A seventh mode of the means for securement M of the lenses to the frame of eyewear is seen in FIGS. 20a and 20b. The first component includes of the body 130 for engagement to a lens holding member. Also shown are actuating nipples 132, flanges 134, detents 136, and a spring 135 employed as a means for biasing, as shown better in the exploded view in FIG. 20b. The second component of the means for securement M includes a body 140, cavities 142, biasing protrusion 144 and slots 146. In operation the protrusion 144 cooperates to engage with the detents 136 on the translating biased nipples 132 on the first component, to provide biased engagement of the protrusion 144 with the detents 136 at selected rotational positions. This allows for positioning of the lenses engaged to the body 130, to stop at any of the plurality of positions and be maintained.

Upon engagement, the slot 146 actuates the nipples 132 inward to allow the first component of the means for securement to engage fully into the second component of this means for securement, to define the securement means M which allows for rotational positioning of a lens or lenses relative to the eyes and face of a user. The flange 134 and slot 146 restrict the orientation of attachment/detachment. When rotated, the first component forming the means for securement M, remains stationary as the second component rotates about the flange 134 in cavity 142. Again, rotational positioning of an engaged lens or lenses is maintained by the detent mechanism defined by the nipple detents 136, protrusion 144, and biasing spring 135 translating the nipples 132 outward. This means for securement M works especially well where the user may wish to position the lenses L out of the field of view, but overhead to provide shade in a horizontal positioning relative to the line of sight.

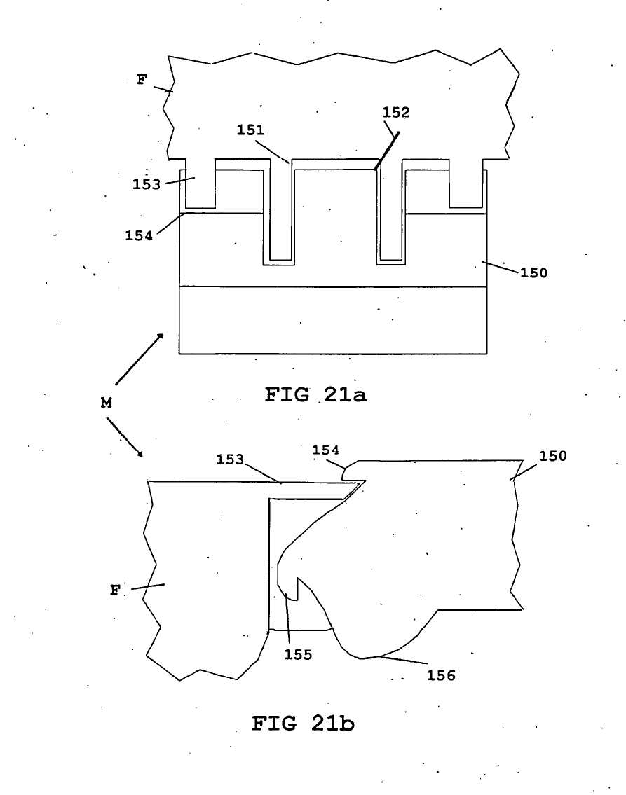

FIG. 21a shows an eighth mode or a means for securement M of a lens bearing body or component to a frame engageable to a user's head. The rotating body 150 is rotationally engaged to a frame F by means of hinges 151. A biasing spring 152 maintains an upward rotational biasing force, namely to urge the engaged lens frame or lens L toward a substantially flipped-up or vertical position of the rotating body 150 relative to the line of sight of the user which is horizontal. It must be noted that the rotating body 150 may incorporate any of the previously described means for removable engagement to the lens L such as a flange and slot system or actuating release. A sear 153 protruding from the frame F engages cooperatively with steps 154, 155 to define biased rotational positions of the rotating body such as a substantially horizontal position 154 to the as-used position 155. A side view is seen in FIG. 21b.

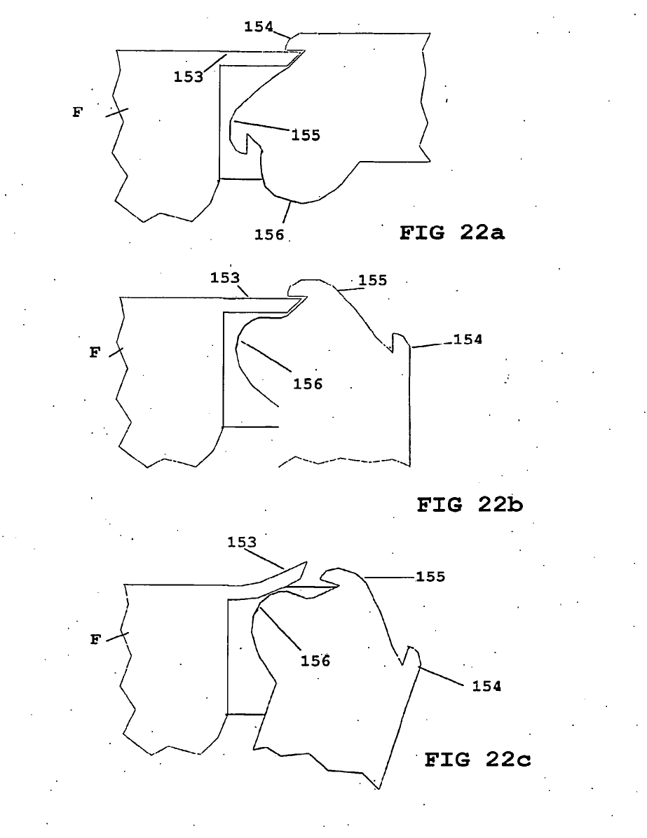

FIG. 22a again shows the rotating body 150 in a substantially horizontal position biased as such by the sear 153 within the first step 154. A user then rotates the body 150 downward allowing the sear 154 to deflect and then rest into the second step 155 defining the as-used position (FIG. 22b). It is noted however that intermediate positions may also be present but two were given merely as a simple descriptive means. To return the rotating body 150 and therefor lens L (not shown) to the stored substantially horizontal position the user then rotates the body further as the releasing protrusion 156 deflects the sear 153 upward releasing it from step 155 (FIG. 22c). This deflection provides clearance for the sear 153 to clear the step 155 and due to the rotational bias provided by the spring 152 within the hinge 151 to the initial position as shown in FIG. 22a.

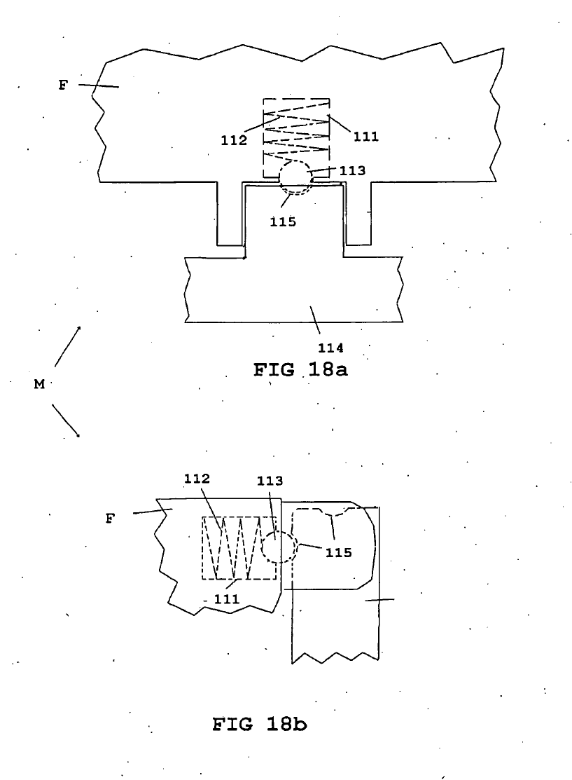

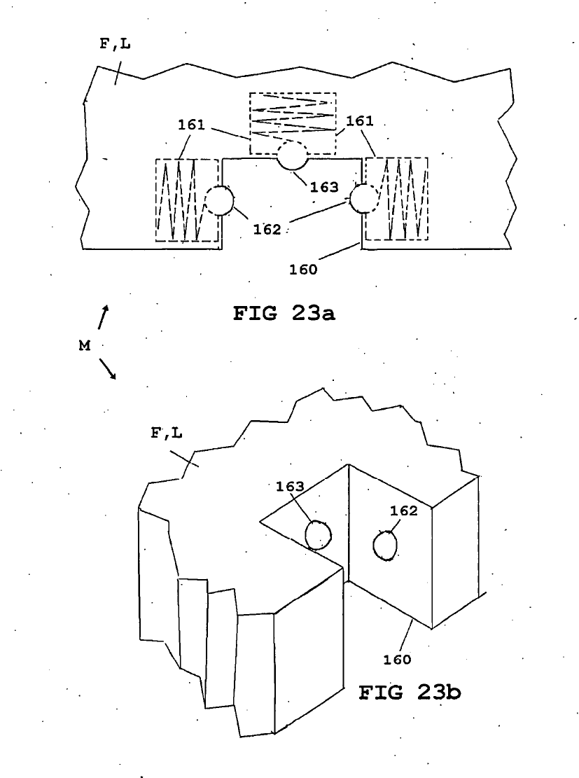

A ninth mode of showing means for securement M for the engagement of a lens bearing frame or body to a head-engageable frame, is shown in FIG. 23a. A rectangular recess 160 defined by three walls and employs ball and spring 161 type biasing means such as that described previously in FIG. 18a.

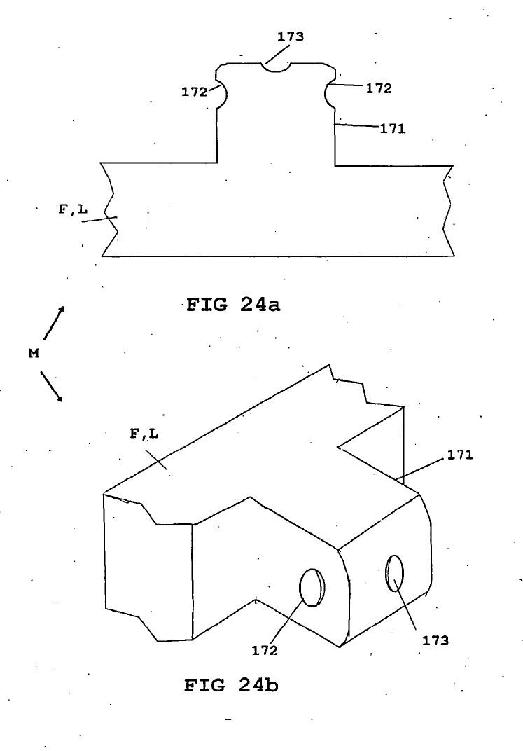

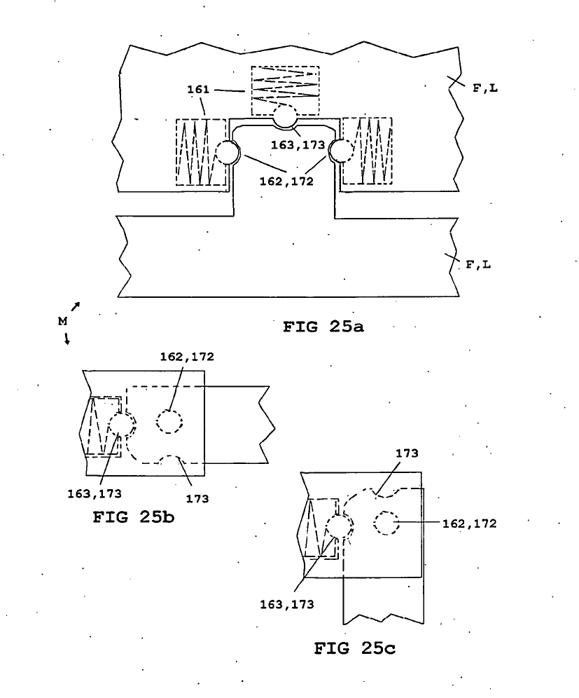

The laterally opposing balls 162 are biased into detents, as a removable means to engage cooperatively with detents (FIG. 24a) and to define an axis point of rotation for a rotating body which holds a lens or lenses (FIG. 24a), while the third ball 163 provides a detent system for biased rotational removably fixed positioning. Another view is seen in FIG. 23b. It should be noted that this component can be employed on either the frame F or lens L to provide the means for securement M for the two. The corresponding mode of the second component can be seen in FIG. 24a. Protrusion 171 engages within the recess 160 of the first component and maintains a biased engagement via the balls 162 within detents 172 as shown in FIG. 25a. Ball 163 along with detents 173 provide means for rotational biasing as depicted in FIGS. 25b and 25c.

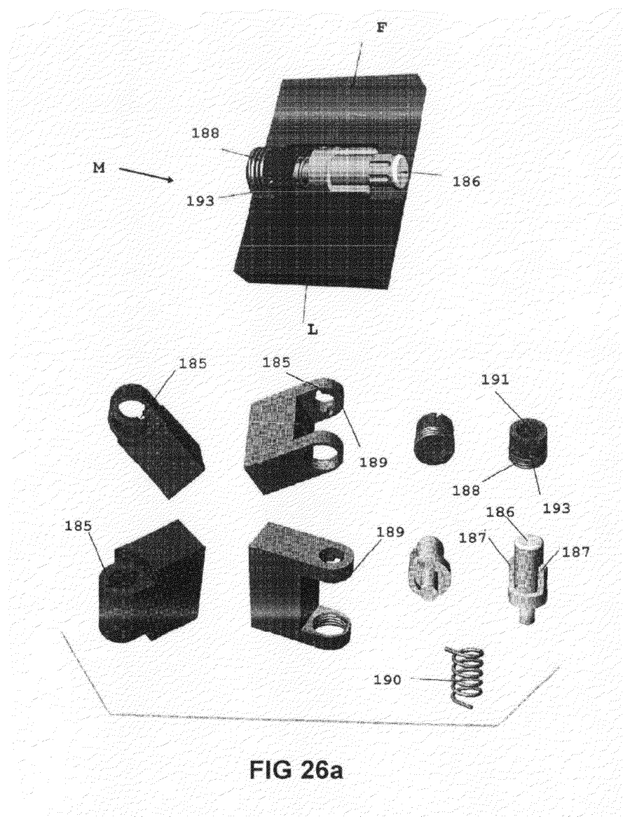

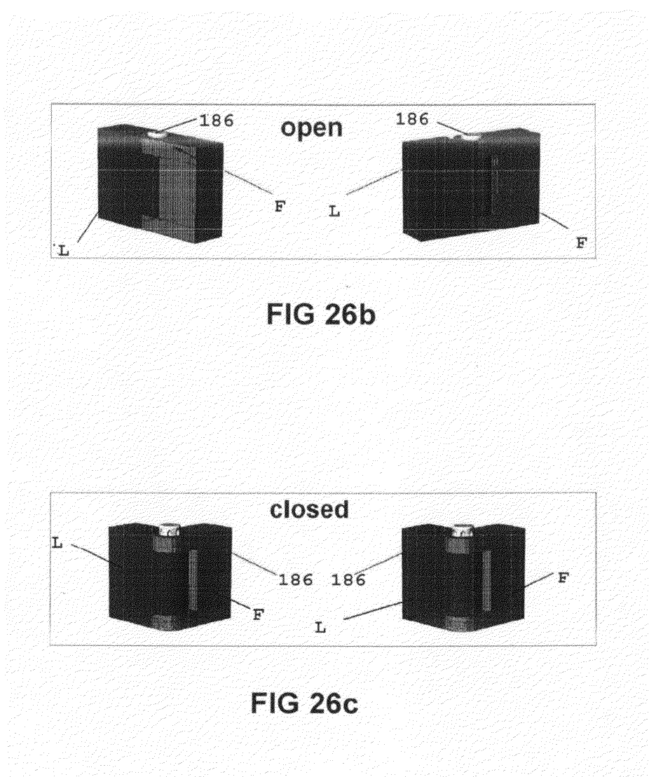

FIG. 26a depicts an exploded view of a tenth mode of the means for securement M of a lens bearing frame L or member to a head engageable frame F worn by a user, showing the frame F engaging the lens L in a cooperative engagement and having recesses formed to yield a cavity 191 when so engaged. The cavity 191 is configured to hold the pushbutton 186 and spring 190 and screw 188 in an operative engagement. Slots 185 formed into the frame F component and lens L component are positioned to align only when the component bearing a lens L reaches the closed position shown in FIG. 26c. This provides a means to lock default movement to outwardly bias the component holding a lens L substantially perpendicular to the component configured to mount on the user's head, or frame F.

Release from the locked position shown in the closed position of FIG. 26c, which is accomplished by depressing the pushbutton 186, to disengage the fins 187 in communication with the pushbutton 186 from the slots 185 formed in the component bearing the lens L. This allows the rotational biased pin 186 to rotate the component bearing a lens L using a rotational force imparted at the threaded engagement of the screw 188 and component bearing a lens L. During this rotation, the circumference of the pin 186 below the fins 187 provides for smooth rotation of the components toward and away from each other, acting as a hinge pin.

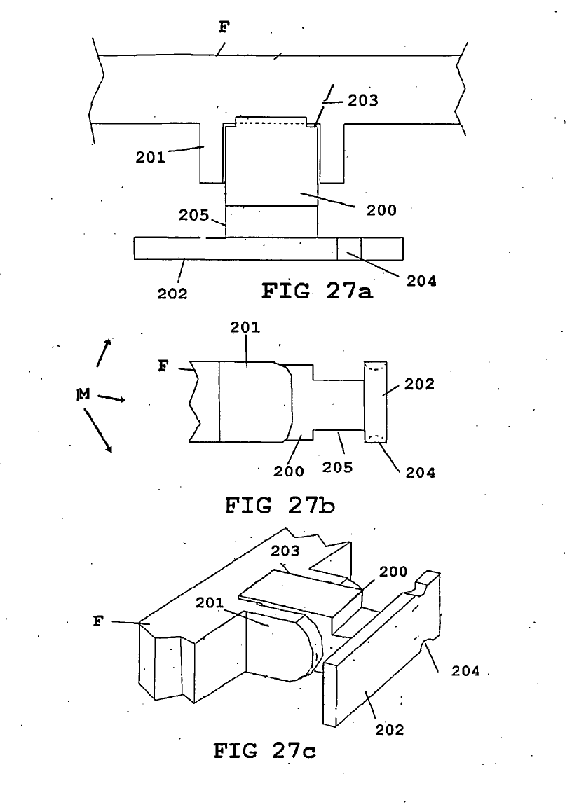

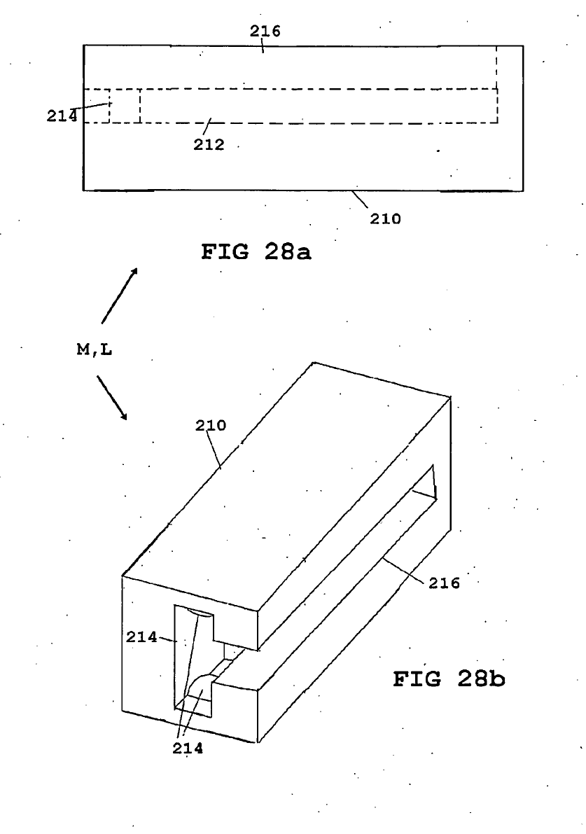

An eleventh mode of engagement of a lens bearing component L to a head engageable frame F, is shown in top view in FIG. 27a. Rotating body 200 is rotationally engaged to the component providing the frame F via hinges 201. The engagement is biased to move the component bearing the lens L, to a flipped up position relative to the viewing of a wearer, by spring 203 within the hinge 201. The rotating body 200 is engaged to the rectangular guide portion 202 with notches 204 via neck portion 205. The guide portion 202 engages cooperatively with the receiving component (FIG. 28a) to define a coupling means. Side an profile views are seen in FIGS. 27b and 27c respectively. The second component can be seen in its eleventh mode in FIG. 28a. Rectangular body 210 has guide channel 214 for slidable engagement with the guide portion 202 of the first component. Upon engagement, biasing protrusions 214 rest within notches 204 defining a biased coupling means. Clearance channel 216 provides clearance for the body 210 and the neck 205 of rotating body 200.

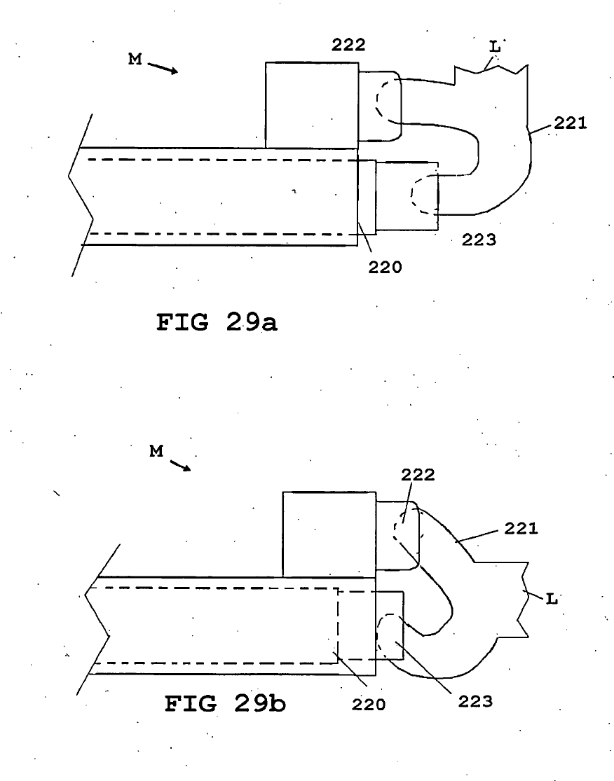

Another mode of the means for securement M of a lens bearing component L to a head mountable frame F, is seen in FIG. 29a. An actuating hydraulic cylinder 220 translates horizontally while biasing to rotate a rotating body 221 bearing the lenses, from a horizontal to a vertical (as-used) position in front of the user's eyes, about hinges 222, 223. The rotating body 221 employs a means for removable engagement to the lens L. The removable engagement may take on any modes previously described, such as a flange/slot system, while the component described merely provides a means for rotational positioning.

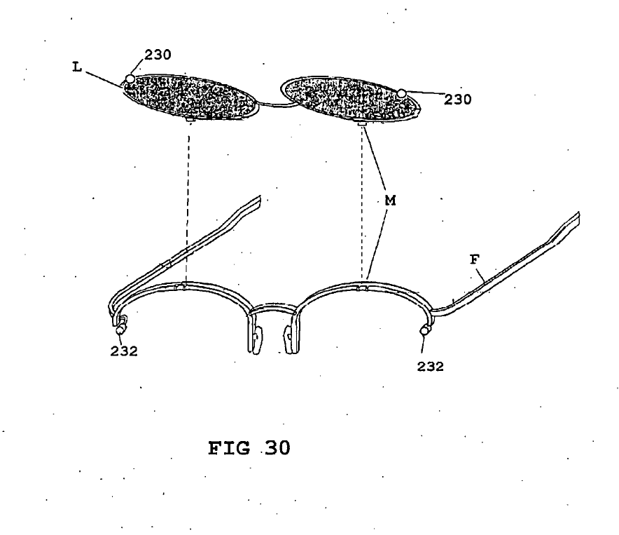

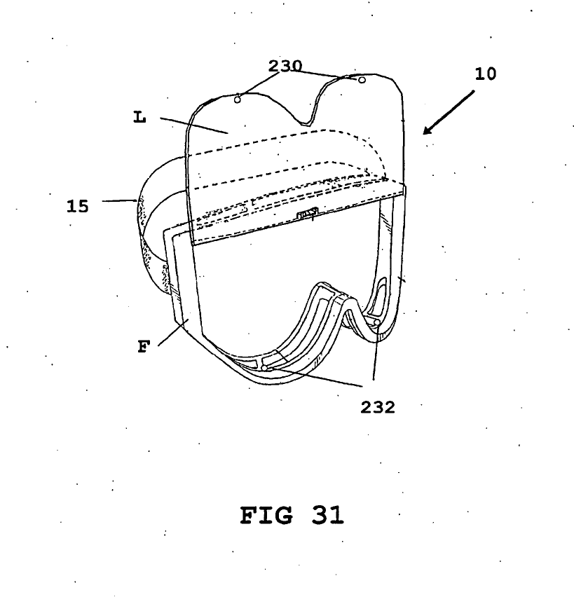

As seen in FIG. 30 is a preferred mode of the device employing a different means for biasing constantly, to rotate the component bearing lenses or a lens L, to a stowed position when not held by a fastener or lock. Magnetic components 230 and 232 are engaged to the frame F and lens body L respectively. The magnetic components 230 and 232 engage cooperatively to maintain the upwardly biased lens L in the as-used position substantially vertical. Similar magnetic position holding means can be seen in another mode of the invention 10 in FIG. 31.

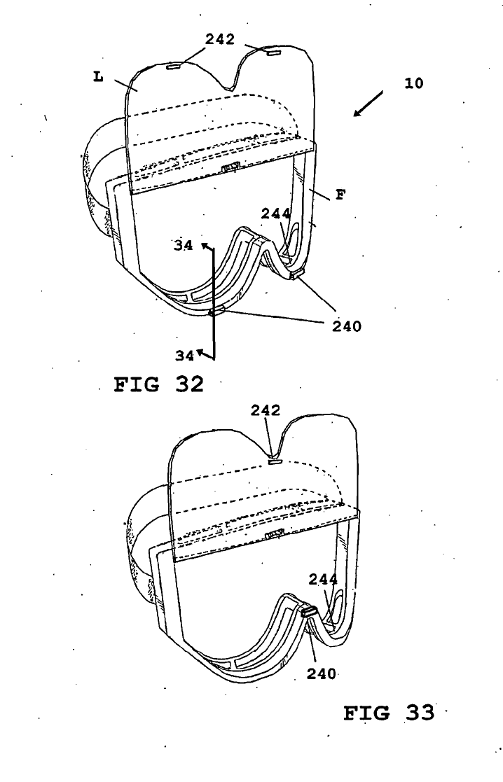

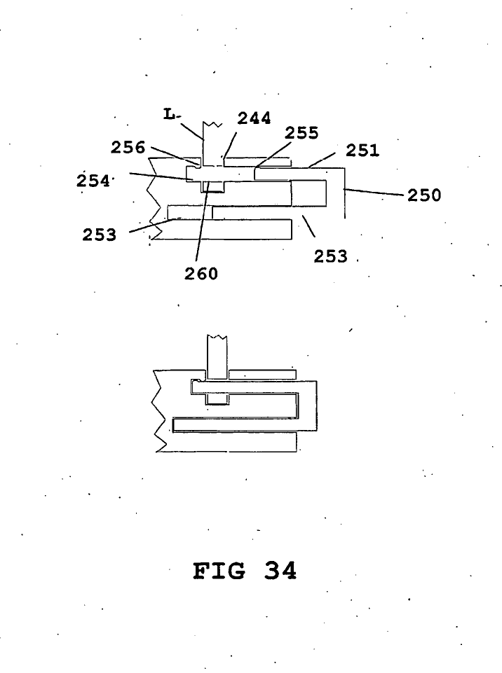

It is desired to have additional positioning means to maintain the as-used position of the lens L in line in operative engagement with the frame F. FIG. 32 shows a perspective view of the invention 10 employing a plurality of slide lock mechanisms 240 to achieve this goal. In this mode the lens L has slot portions 242 to accept a locking means. Cross-sectional view are seen in FIG. 34 as depicted when in the as-used position. The lens L engages into groove 244. Element 250 is slidably engaged into channels 253, 254 in the frame F via extending elements 251, 252. To lock, sliding element 250 is translated into the channels 253, 254 through slot 260 and locked into place via frictional elements 255, 256 as depicted.

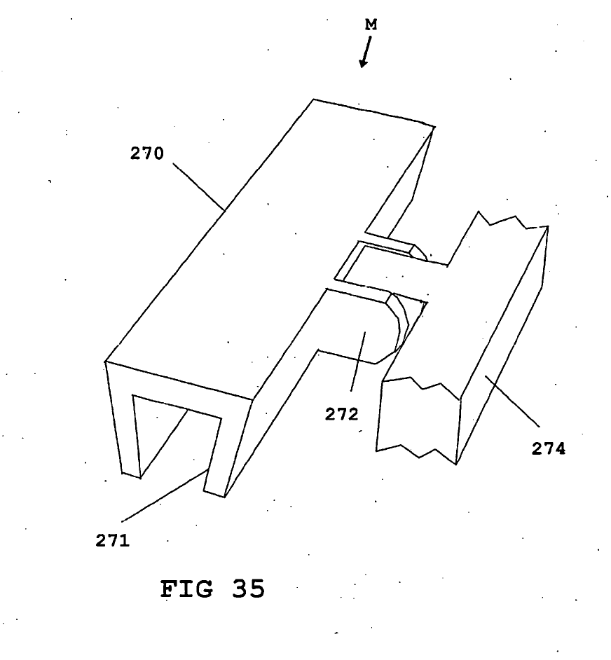

A further mode of the disclosed rotational engagement of a lens or lenses to head mounted frames is seen in FIG. 35. In this mode, the means for securement M itself, can be removably engaged to an existing spectacle frame via frictional engagement means 270. This mode does not require a head engageable frame F as described previously but ‘clips on’ to any functional frame of an existing eye wear frame such as corrective lens glasses or sunglasses. The tapered channel 271 provides a frictional biasing means to secure a hinge 272 and rotating body 274 to the existing frame (not shown). In the figure, however, an arbitrary rotating body 274 is shown, but it must be noted that any of the rotating bodies as described in the different modes of the means for securement can encompass this rotating body to achieve the respective means for releasable securement of a front lens body 20.

As noted, all modes of the component holding lenses or a lens L, whether as a lens by itself or in combination with a lens bearing frame, are preferably rotationally engaged to a head mountable frame F such that the lens frame bearing the lens L, or a lens L, are biased to rotate to a horizontal stowed position if not held in the as-used position by a securement means or lock. This allows the user to simply release the securement and the lens L will rotate out of the sight line. Further, it is preferred that the lenses L, are removably engaged to the frame F. This allows any lense having tinting, polarization, or for media watching and bearing any Left (L) or Right (R) optics scheme to be employed to match that of the video or media being displayed.

Further, the device as shown and described is adapted to employ any of a plurality of lenses L, in a kit form having multiple types of tinted and polarized lenses to any mode of the head engaging frame F, such that new optics schemes may be accommodated by new lenses L which attach. Still further, proprietary lenses L in frames or as lenses themselves adapted to engage a Frame F, may be employed by manufacturers as a means to reduce media piracy. This would allow customized lenses L with custom right (R) and left (L) optics to be provided which match the media distributors projection screen or method.

While all of the fundamental characteristics and features of the invention have been shown and described herein, with reference to particular modes thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An eyewear apparatus, comprising:
a frame;
means to maintain said frame in an as-used position substantially horizontally disposed, above the eyes of a user;
at least one lens assembly;
said lens having a first viewing portion positionable adjacent to a right side of said user's nose;
said lens assembly having a second viewing portion positionable adjacent to a left side of said user's nose opposite said first side;
a pivotable engagement of said frame with said lens assembly providing rotation between a raised position substantially above said user's eyes, and a lowered position disposed in front of said user's eyes;
said first viewing portion of said lens assembly having first lens area configured to allow a right-eye image of a 3D projection, to pass therethrough; and
said second viewing portion of said lens assembly having a second lens area configured to allow a left-eye image of a 3D image, to pass therethrough, whereby said lens assembly is moveably by said user between said raised position providing an unfiltered viewing from said user's eyes and said lowered position providing filtered viewing of said 3D image through said first viewing portion and said second viewing portion.

2. The eyewear apparatus of claim 1, additionally comprising:
said lens assembly formed of a single lens having said first viewing portion and said second viewing portion operatively positioned thereon.

3. The eyewear apparatus of claim 1, additionally comprising:
said lens assembly formed of two individual lenses engaged to a bridge; and
said first viewing portion positioned on a first lens and said second viewing portion positioned on a second lens.

4. The eyewear apparatus of claim 2 additionally comprising:
a removable engagement of said lens assembly to said frame; and
said removable engagement allowing a use of said frame without said lens assembly.

5. The eyewear apparatus of claim 3 additionally comprising:
a removable engagement of said lens assembly to said frame; and
said removable engagement allowing a use of said frame without said lens assembly.

6. The eyewear apparatus of claim 2 additionally comprising:
a biasing component in communication with said lens assembly;
said biasing component imparting a bias upon said lens assembly toward said raised position;
a releasable retaining component for maintaining said lens assembly in said lowered position;
a user activated release of said retaining component, said lens assembly automatically moving to said raised position upon an activation of said release.

7. The eyewear apparatus of claim 3 additionally comprising:
a biasing component in communication with said lens assembly;
said biasing component imparting a bias upon said lens assembly toward said raised position;
a releasable retaining component for maintaining said lens assembly in said lowered position;
a user activated release of said retaining component, said lens assembly automatically moving to said raised position upon an activation of said release.

8. The eyewear apparatus of claim 4 additionally comprising:
a biasing component in communication with said lens assembly;
said biasing component imparting a bias upon said lens assembly toward said raised position;
a releasable retaining component for maintaining said lens assembly in said lowered position;
a user activated release of said retaining component, said lens assembly automatically moving to said raised position upon an activation of said release.

9. The eyewear apparatus of claim 5 additionally comprising:
a biasing component in communication with said lens assembly;
said biasing component imparting a bias upon said lens assembly toward said raised position;
a releasable retaining component for maintaining said lens assembly in said lowered position;
a user activated release of said retaining component, said lens assembly automatically moving to said raised position upon an activation of said release.

10. The eyewear apparatus of claim 2 additionally comprising:
corrective lenses engaged to said frame;
said lens assembly in said lowered position providing a viewing to said user of said right-eye image of a 3D projection through a first of said corrective lenses;
said lens assembly in said lowered position providing a viewing to said user of said left-eye image of a 3D projection through a second of said corrective lenses; and
whereby said user can employ said corrective lenses for normal viewing with said lens assembly in said raised position and view said 3D projection through said corrective lenses with said lens assembly in said lowered position.

11. The eyewear apparatus of claim 3 additionally comprising:
corrective lenses engaged to said frame;
said lens assembly in said lowered position providing a viewing to said user of said right-eye image of a 3D projection through a first of said corrective lenses;
said lens assembly in said lowered position providing a viewing to said user of said left-eye image of a 3D projection through a second of said corrective lenses; and
whereby said user can employ said corrective lenses for normal viewing with said lens assembly in said raised position and view said 3D projection through said corrective lenses with said lens assembly in said lowered position.

12. The eyewear apparatus of claim 4 additionally comprising:
corrective lenses engaged to said frame;
said lens assembly in said lowered position providing a viewing to said user of said right-eye image of a 3D projection through a first of said corrective lenses;
said lens assembly in said lowered position providing a viewing to said user of said left-eye image of a 3D projection through a second of said corrective lenses; and
whereby said user can employ said corrective lenses for normal viewing with said lens assembly in said raised position and view said 3D projection through said corrective lenses with said lens assembly in said lowered position.

13. The eyewear apparatus of claim 5 additionally comprising:
corrective lenses engaged to said frame;
said lens assembly in said lowered position providing a viewing to said user of said right-eye image of a 3D projection through a first of said corrective lenses;
said lens assembly in said lowered position providing a viewing to said user of said left-eye image of a 3D projection through a second of said corrective lenses; and
whereby said user can employ said corrective lenses for normal viewing with said lens assembly in said raised position and view said 3D projection through said corrective lenses with said lens assembly in said lowered position.

14. The eyewear apparatus of claim 6 additionally comprising:
corrective lenses engaged to said frame;
said lens assembly in said lowered position providing a viewing to said user of said right-eye image of a 3D projection through a first of said corrective lenses;
said lens assembly in said lowered position providing a viewing to said user of said left-eye image of a 3D projection through a second of said corrective lenses; and
whereby said user can employ said corrective lenses for normal viewing with said lens assembly in said raised position and view said 3D projection through said corrective lenses with said lens assembly in said lowered position.

15. The eyewear apparatus of claim 7 additionally comprising:
corrective lenses engaged to said frame;
said lens assembly in said lowered position providing a viewing to said user of said right-eye image of a 3D projection through a first of said corrective lenses;
said lens assembly in said lowered position providing a viewing to said user of said left-eye image of a 3D projection through a second of said corrective lenses; and
whereby said user can employ said corrective lenses for normal viewing with said lens assembly in said raised position and view said 3D projection through said corrective lenses with said lens assembly in said lowered position.

16. The eyewear apparatus of claim 8 additionally comprising:
corrective lenses engaged to said frame;
said lens assembly in said lowered position providing a viewing to said user of said right-eye image of a 3D projection through a first of said corrective lenses;
said lens assembly in said lowered position providing a viewing to said user of said left-eye image of a 3D projection through a second of said corrective lenses; and
whereby said user can employ said corrective lenses for normal viewing with said lens assembly in said raised position and view said 3D projection through said corrective lenses with said lens assembly in said lowered position.

17. The eyewear apparatus of claim 9 additionally comprising:
corrective lenses engaged to said frame;
said lens assembly in said lowered position providing a viewing to said user of said right-eye image of a 3D projection through a first of said corrective lenses;
said lens assembly in said lowered position providing a viewing to said user of said left-eye image of a 3D projection through a second of said corrective lenses; and
whereby said user can employ said corrective lenses for normal viewing with said lens assembly in said raised position and view said 3D projection through said corrective lenses with said lens assembly in said lowered position.

18. The eyewear apparatus of claim 4 additionally comprising:
said raised position positioning said lens assembly with said first and second lens portions substantially vertically disposed in an orientation opposite said lowered position; and
said removable engagement configured to allow a removal of said lens assembly only in a removal position, said removal position having said first and second lens portions projecting from said frame in a substantially horizontal position between said raised position and said lowered position.

19. The eyewear apparatus of claim 5 additionally comprising:
said raised position positioning said lens assembly with said first and second lens portions substantially vertically disposed in an orientation opposite said lowered position; and
said removable engagement configured to allow a removal of said lens assembly only in a removal position, said removal position having said first and second lens portions projecting from said frame in a substantially horizontal position between said raised position and said lowered position.

20. The eyewear apparatus of claim 13 additionally comprising:
said raised position positioning said lens assembly with said first and second lens portions substantially vertically disposed in an orientation opposite said lowered position;
said retaining component communicating with said lens assembly and providing a holding of said lens assembly to any of a plurality of incremental angled positions of said lens assembly, between said raised position and said lowered position; and
said lens assembly moveably by a rotation by said user to any of said incremental positions.
